(19) United States
(12) Patent Application Publication
(10) Pub. No.: US 2004/0151006 A1
(43) Pub. Date: Aug. 5, 2004

(54) Backlight device for light emitting diode

(76) Inventor: Pang-Lun Yang, Taichung (TW)

Correspondence Address: QUINTERO LAW OFFICE, 1617 BROADWAY, 3RD FLOOR, SANTA MONICA, CA, 90404, US

(21) Appl. No.: 10/747,374

(22) Filed: Dec. 29, 2003

(30) Foreign Application Priority Data
Jan. 30, 2003 (TW) 92102171

(51) Int. Cl. H01J 5/16

(52) U.S. Cl. 362/558

(57) ABSTRACT

A backlight device for light emitting diodes (LEDs). The backlight device includes a light guiding plate and a plurality of LEDs. The light guiding plate has a first surface, a second surface parallel to the first surface, a pattern for guiding light being formed on the first surface, and a plurality of openings being defined on the second surface. The LEDs are positioned in the openings. Lights of the LEDs reach the light guiding plate via the second surface and transmit out of the light guiding plate from the first surface.

### BACKGROUND OF THE INVENTION

1. Field of the Invention

The present invention relates to a backlight device for light emitting diodes (LEDs) and especially to a backlight device having a light guiding plate with a plurality of openings to position the LEDs.

2. Description of the Related Art

Recently, liquid crystal displays (LCDs) have replaced the cathode ray tube (CRT) displays in the mainstream market, because of lower radiation and smaller profile. Usually, cold cathode fluorescent lamps (CCFLs) are used as light sources in backlight modules of the traditional LCDs. However, the CCFLs have problems to turn on at lower temperatures. Therefore, heaters are needed for LCDs with CCFLs in some environments so as to wasting idling times before turning on CCFLs. Due to these problems, light emitting diodes (LEDs) are gaining popularity as light sources in the backlight modules.

A traditional display using the LEDs as light sources in the backlight module is disclosed in Taiwan Patent No. 476453. The structure is hereinafter described in detail.

FIG. 1 shows an exploded view of the traditional LED backlight module. The traditional LED backlight module includes a light-shielding layer 15, a light guiding plate 11, a reflecting plate 16, a diffusing sheet 17, a circuit board 12, and a plurality of LEDs 13. The LEDs 13 are disposed on at least one side of the light guiding plate 11 as the light sources. Light emitted from the LEDs passes through the light guiding plate 11 and the diffusing sheet 17, and then emitted from the backlight module. The reflecting plate 16 can reflect lights back to the light guiding plate 11. The light-shielding layer 15 is used to prevent uneven light zones above the LEDs; in addition, the light-shielding layer 15 is also used to fix the circuit board 12 and prevent from light leaking from the other side of the light guiding plate 11.

In the traditional LED backlight module, however, the brightness of the back light module is not uniform because the LEDs 13 are disposed on the side of the light is guiding plate 11 and the incident lights of the LEDs might be undesired. Furthermore, the uneven light zones of the LEDs 13 cannot be fully eliminated by the light-shielding layer 15. Accordingly, uniformity of brightness of the LED backlight module might be deteriorated.

### SUMMARY OF THE INVENTION

Accordingly, an object of the invention is to provide a backlight device for a plurality of light emitting diodes (LEDs). The backlight device includes a light guiding plate and a plurality of LEDs. The light guiding plate has a first surface, a second surface parallel to the first surface, a pattern for guiding light being formed on the first surface, and a plurality of openings being defined on the second surface. The LEDs are positioned in the openings, respectively. Lights of the LEDs reach the light guiding plate via the second surface and transmit out of the light guiding plate from the first surface.

According to the present invention, LEDs is embedded in the openings to reduce the thickness of the backlight device and increase the incidence ratio of lights in the light guiding plate. Accordingly, a backlight device with a good uniformity and a higher brightness can be obtained.

A detailed description is given in the following embodiments with reference to the accompanying drawings.

### BRIEF DESCRIPTION OF THE DRAWINGS

The present invention is more fully understood by reading the subsequent detailed description and examples with references made to the accompanying drawings, wherein:

FIG. 1 shows an exploded view of the traditional LED backlight module;

FIG. 2 is a cross-sectional view showing an embodiment of the backlight device of the present invention;

FIG. 3 is a perspective view of the light guiding plate in the backlight device of the present invention.

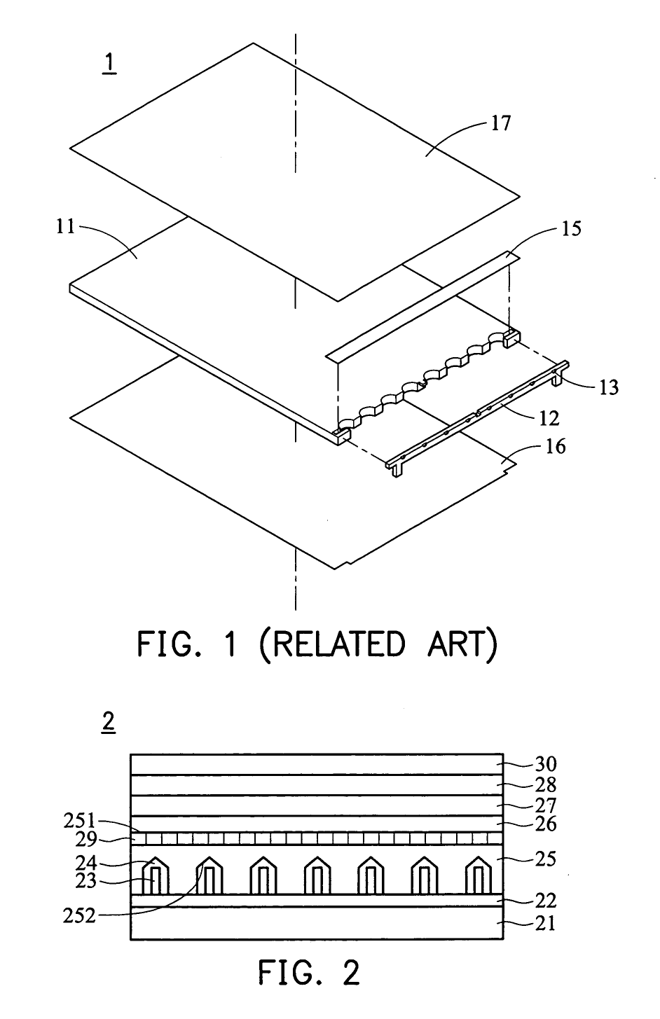

### DETAILED DESCRIPTION OF THE INVENTION

FIG. 2 is a cross-sectional view showing an embodiment of the backlight device of the present invention. In the embodiment, a printed circuit board (PCB) 21 is provided as a base of the backlight device, and a reflecting plate 22 is disposed on the printed circuit board 21. A plurality of LEDs 23 is provided to be electrically connected with the printed circuit board 21. The circuit layout is formed on the PCB 21 according to the number of the LEDs. Furthermore, the surface mount technology (SMT) can be applied to electrically connect the LEDs 23 to the printed circuit board 21. In another embodiment, the LEDs 23 can be mounted on an additional substrate.

The light guiding plate 25 has a first surface 251, a second surface 252 parallel to the first surface 251, and a plurality of openings 24 being defined on the second surface 252. The LEDs 23 are embedded in the light guiding plate 25 corresponding to the openings 24. The light guiding plate 25 can be made of polymethylmethacrylate (PMMA) or polycarbonate (PC) and is formed by injection molding technology. The light guiding plate 25 also has a pattern 29 for guiding lights, which is formed on the first surface 251 and may be jagged or uneven. Thus, lights of the LEDs reach the light guiding plate 25 via the second surface 252 and transmit out of the light guiding plate 25 from the first surface 251. The lights can be distributed broadly when passing through the light guiding pattern 29, and a backlight device with a uniformity of brightness can be obtained.

For increasing the uniformity of brightness and reducing light loss of the backlight device, a diffusing device is disposed on the first surface 251 of the light guiding plate 25. The diffusing device includes a protecting film 26, a first prism film 27, a second prism film 28 and a diffusing film 30. The diffusing film 30 increases the uniformity of brightness, and the first prism film 27 reduces light loss by scattering and diffusion.

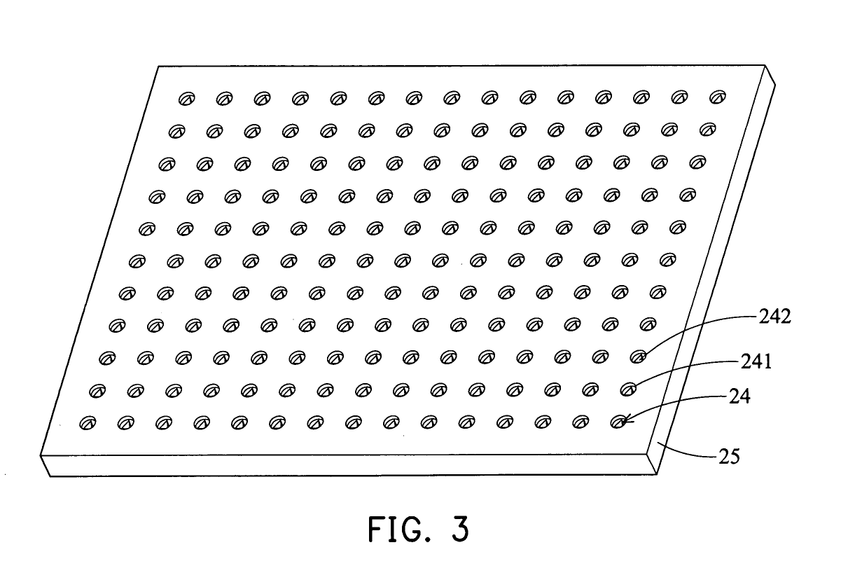

FIG. 3 is a perspective view of the light guiding plate in the backlight device of the present invention. The array type openings 24 are formed on the light guiding plate 25 and the LEDs are embedded in the openings 24 and electrically connected to the printed circuit board 21. Since the LEDs are disposed below and embedded in the light guiding plate 25, the backlight device of the present invention has a high uniformity of brightness.

Furthermore, the openings 24 match the shapes of the LEDs so that the LEDs can be embedded therein, and thus each of the opening 24 can be formed in a substantially circular shape so as to allow more lights of the corresponding LED to enter the light guiding plate 25. In the present invention, the light guiding plate 25 is integral and formed by injection molding technology. It is also acceptable to form the openings in other shapes, e.g. a shape of a triangular prism, to provide required incidence of light according to different LEDs.

While the invention has been described by way of example and in terms of the preferred embodiments, it is as understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight device comprising:
a light guiding plate having a first surface, a second surface parallel to the first surface, a pattern for guiding light being formed on the first surface, and a plurality of openings being defined on the second surface; and
a plurality of LEDs (light emitting diode) positioned in the plurality of openings;
wherein lights of the LEDs reach the light guiding plate via the second surface and transmit out of the light guiding plate from the first surface.

2. The backlight device as claimed in claim 1, wherein each of the openings is in a substantially circular shape.

3. The backlight device as claimed in claim 1, wherein each of the openings has a shape of a triangular prism.

4. The backlight device as claimed in claim 1, further comprising a diffusing device disposed on the first surface.

5. The backlight device as claimed in claim 4, wherein the diffusing device comprises:
a protecting film disposed on the first surface;
a prism film disposed on the protecting film; and
a diffusing film disposed on the prism film.

6. The backlight device as claimed in claim 1, further comprising:
a diffusing sheet disposed on the first surface of the light guiding plate; and
a reflecting plate, wherein the LEDs are disposed between the reflecting plate and the light guiding plate.

7. The backlight device as claimed in claim 1, wherein the light guiding plate is made of polymethylmethacrylate (PMMA).

8. The backlight device as claimed in claim 1, wherein the light guiding plate is made of polycarbonate (PC).

9. The backlight device as claimed in claim 1, wherein the light guiding plate is formed by injection molding technology.

10. The backlight device as claimed in claim 1, further comprising a printed circuit board electrically connected with the LEDs.
